(19) United States
(12) Patent Application Publication
(10) Pub. No.: US 2026/0099315 A1
(43) Pub. Date: Apr. 9, 2026

(54) METHODS AND NETWORK NODES FOR CANARY RELEASE

(71) Applicant: Telefonaktiebolaget LM Ericsson (publ), Stockholm (SE)

(72) Inventors: Pablo MARTINEZ DE LA CRUZ, Madrid (ES); Maria Cruz BARTOLOME RODRIGO, Madrid (ES); Xinyu ZHANG, Shanghai (CN)

(21) Appl. No.: 19/116,502

(22) PCT Filed: Sep. 29, 2022
(86) PCT No.: PCT/CN2022/122484

§ 371 Date: Mar. 28, 2025

(51) Int. Cl. G06F 8/65; H04L 41/08; H04L 41/082

(52) U.S. Cl. CPC G06F 8/65; H04L 41/082; H04L 41/0886

(57) ABSTRACT

The disclosure provides a first network node. The first network node includes at least one processor; and at least one memory, coupled with the at least one processor and stored thereon instructions which, when executed by the at least one processor, cause the first network node to perform operations including: receiving an indication for activating canary release of a feature in a communication network; and providing an automatic orchestration for the canary release of the feature across network functions, NFs, within a signaling path in the communication network.

### TECHNICAL FIELD

The present disclosure generally relates to the technical field of telecommunication, and particularly to methods and network nodes for canary release in telecommunication networks.

### BACKGROUND

The 3^{rd} Generation Partnership Project (3GPP) defines a Service Based Architecture (SBA) for the Fifth Generation (5G) System, as specified in TS 23.501.

The SBA non-roaming architecture, i.e., 5G System Architecture from FIG. 4.2.3-1 of TS 23.501, is schematically illustrated in FIG. 1.

As shown in FIG. 1, some other examples of a core network node in the 5G System Architecture include a node implementing a Access and Mobility Management Function (AMF), a User Plane function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), Application Function (AF), or the like. Radio Access Node (RAN), Data Network (DN) and User Equipment (UE) are also shown in FIG. 1.

N_{nssf}, N_{nef}, N_{nrf}, N_{pcf}, N_{udm}, N_{af}, N_{ausf}, N_{amf} and N_{smf} shown in FIG. 1 represent service-based interfaces exhibited by respective network nodes. The services that a NF provides to other authorized NFs can be exposed to the authorized NFs through the service-based interfaces. The service-based interfaces are indicated by the letter “N” followed by the name of the NF, e.g. N_{amf} for the service-based interface of the AMF and N_{smf} for the service-based interface of the SMF etc.

FIG. 1 also shows some reference points, e.g., N1, N2, N3, N4, N6, N9 contained in the 5G system Architecture. Reference points of the 5G network architecture are used to develop detailed call flows in the normative standardization. For example, the N1 reference point is defined to carry signaling between the UE and AMF.

The core 5G network architecture is composed of modularized functions. For example, the AMF and SMF are independent functions in the control plane. Separated AMF and SMF allow independent evolution and scaling. Modularized function design enables the 5G core network to support various services flexibly.

Network Functions (NFs) of the 5G System use service-based interactions to consume services from other NFs.

The discovery of services and NFs providing them is provided by the Network Repository Function (NRF). Producer NFs exposing services shall register a NF profile within the NRF describing the services offered by the NF and how to consume them. Consumer NFs shall query the NRF for services being consumed, to obtain the required service information.

NF Profiles are described in 3GPP TS 29.510, section 6.2.6. An NF profile contains information about a Producer NF, including among other types of information, addressing details, that is, information about the endpoints that can be used to consume services from the Producer NF.

The attributes for NF Profiles and NF Services are described in sections 6.2.6.2.3 and 6.2.6.2.4, respectively.

Canary release is a technique to reduce the risk of introducing a new software version in production by slowly rolling out the change to a small either a percentage of traffic or subset of users (selected users or group of users fulfilling some criteria), before rolling it out to the entire infrastructure and making it available for full traffic or whole amount of user.

There is an interest in the telecommunications industry to leverage canary releases to reduce the time to market and cost associated to the rollout of new features and use cases. The 5G SBA and the implementation of the same with cloud native principles in many of the vendors facilitates such interest.

Network features usually require several NFs and/or NF Services within the signaling path to be upgraded with new software in order to realize the feature of end to end at network level.

Canary release of said features requires special handling to ensure that the signaling path traverses the NF/NF Services that have been upgraded as well. Otherwise, the feature is partially tested, and unwanted effects in the signaling may occur.

In this situation, to implement an end to end test of the feature in the signaling path, it often requires awareness of the canary testing in all NFs along the signaling path at network level. However, even though requiring Consumer NF awareness and cooperation may be supported with proprietary techniques in single vendor 5G core deployments, this awareness still challenges the implementation of the canary releases end to end, particularly in multi-vendor scenarios.

This invention proposes a mechanism to alleviate or eliminate the aforementioned problems.

### SUMMARY

In order to provide a mechanism to alleviate or eliminate the aforementioned problems as described above, the present disclosure proposes methods and network node for network canary orchestration according to various embodiments as described below.

Generally, the present disclosure proposes a solution for network canary testing (based on, e.g., a percentage of traffic) without awareness of the canary release in the Consumer NFs.

The Consumer NFs steer the traffic to the canary Producer NF service instance with existing standard NF Service selection algorithm.

The solution is based on the introduction of a new component, i.e., Network Canary Orchestrator (NCO) in 5G core network, for example.

The NCO may identify Producer NFs that requires activation of the canary feature and performs following actions:
NCO may configure the Producer NFs to expose a new NF Service that is used to receive the canary traffic.
The NCO may configure the NF Profile of the Producer NF with the new NF Service, and an indication for the traffic steering criteria to allow routing towards the new NF Service (upgraded canary feature) or regular NF service (original, not upgraded canary feature).
NCO may configure internal traffic routing (based on traffic steering criteria) within the Producer NF to send the received canary traffic to be processed by the upgraded canary feature, and the rest of the traffic being processed by the original feature.

The Producer NF may publish its updated NF Profile in the NRF. Consumer NFs that are subscribed to the Producer NFs may receive notifications about the new available NF Service, and use the traffic steering criteria in the NF Service profile to steer the canary traffic only to the new NF Service.

According to a first aspect of the present disclosure, there is provided a first network node, comprising: at least one processor; and at least one memory, coupled with the at least one processor and stored thereon instructions which, when executed by the at least one processor, cause the first network node to perform operations comprising: receiving an indication for activating canary release of a feature in a communication network; and providing an automatic orchestration for the canary release of the feature across network functions, NFs, within a signaling path in the communication network.

In an embodiment, the providing an automatic orchestration may comprises identifying Producer NFs within the signaling path that requires activation of the canary release of the feature without awareness of the canary release in Consumer NFs within the signaling path.

In an embodiment, the first network node may further comprise a first interface configured for extracting information about the feature with the canary release to be activated and the Product NFs participating in the canary release; and a second interface configured for performing configuration on the Producer NFs participating in the canary release.

In an embodiment, the providing an automatic orchestration may further comprises receiving configuration on the feature with the canary release to be activated and traffic steering criteria for handling canary traffic.

In an embodiment, the providing an automatic orchestration may further comprise identifying the Producer NFs and respective NF services participating in the canary release of the feature based on local configuration or querying via the first interface.

In an embodiment, for each of the Producer NFs, the providing an automatic orchestration further comprises, for each of the NF services offered by the Producer NF, sending an instruction to the Producer NF via the second interface for performing actions comprising: exposing a new NF service for receiving the canary traffic; determining an internal routing within the Producer NF for routing the canary traffic based on the traffic steering criteria; and creating, in a NF profile of the Producer NF, the new NF service and the traffic steering criteria.

In an embodiment, the exposing a new NF service for receiving the canary traffic may comprise: creating a new traffic receiving endpoint corresponding to the new NF service for receiving the canary traffic using at least one of a dedicated IP address, a dedicated FQDN, a dedicated port, and a dedicated API root.

In an embodiment, the new NF service has the same service name and different traffic receiving endpoint than prior NF service.

In an embodiment, the providing an automatic orchestration may further comprise setting priority attribute and capacity attribute of the new NF service and the prior NF service.

In an embodiment, the providing an automatic orchestration may further comprise instructing the Producer NF to publish, in a Network Registration Function, NRF, the NF profile containing at least the new NF service for receiving the canary traffic and the traffic steering criteria for handling the canary traffic.

In an embodiment, the traffic steering criteria may comprise configuration on at least a percentage of the canary traffic and canary traffic routing.

In an embodiment, when the configuration on the percentage of the canary traffic is changed, the providing an automatic orchestration may further comprise sending an instruction to the Producer NFs for performing actions comprising: updating the NF profiles and publishing the updated NF profiles in the NRF.

In an embodiment, when fully rolling out the feature by terminating the canary release, the providing an automatic orchestration may further comprise sending an instruction to the Producer NFs for performing actions comprising: updating the NF profile of each of the Producer NFs participating in the canary release by removing the prior NF service; publishing the updated NF profile in the NRF; and removing prior traffic receiving endpoint corresponding to the prior NF service.

According to a second aspect of the present disclosure, there is provided a method comprises: receiving an indication for activating canary release of a feature in a communication network; and providing an automatic orchestration for the canary release of the feature across network functions, NFs, within a signaling path in the communication network.

In an embodiment, the providing an automatic orchestration in the method may further comprises: extracting, via a first interface, information about the feature with the canary release to be activated and the Product NFs participating in the canary release; and performing, via a second interface, configuration on the Producer NFs participating in the canary release.

According to a third aspect of the present disclosure, there is provided a network node comprising the first network node performing any of methods according to the embodiments of the present disclosure.

According to a fourth aspect of the present disclosure, there is provided a method performed by a second network node, comprising: for each of network function, NF, services offered by the second network node participating in canary release of a feature, receiving, from a first network node, an instruction for performing operations comprising: exposing a new NF service for receiving canary traffic; determining an internal routing within the second network node for routing the canary traffic based on traffic steering criteria for handling the canary traffic; and creating, in a NF profile of the second network node, the new NF service and the traffic steering criteria.

In an embodiment, the exposing a new NF service for receiving the canary traffic may comprise: creating a new traffic receiving endpoint corresponding to the new NF service for receiving the canary traffic using at least one of a dedicated IP address, a dedicated FQDN, a dedicated port, and a dedicated API root.

In an embodiment, the new NF service may have the same service name and different traffic receiving endpoint than prior NF service.

In an embodiment, the method may further comprise, in response to receiving an instruction from the first network node, publishing, in a NRF, the NF profile including at least the new NF service for receiving the canary traffic and the traffic steering criteria for handling the canary traffic.

In an embodiment, the traffic steering criteria may comprise at least configuration on a percentage of the canary traffic.

In an embodiment, when the configuration on the percentage of the canary traffic is changed, the method may further comprise: receiving an instruction from the first network node for performing operations comprising: updating the NF profile and publishing the updated NF profile in the NRF.

In an embodiment, when fully rolling out the feature by terminating the canary release, the method may further comprise: receiving an instruction from the first network node for performing operations comprising: updating the NF profile of the second Network node by removing the prior NF service; publishing the updated NF profile in the NRF; and removing prior traffic receiving endpoint corresponding to the prior NF service.

In an embodiment, the second Network node is a Producer NF participating in the canary release of the feature in a communication network, and the first network node is or comprises a network canary orchestrator, NCO configured to provide an automatic orchestration for the canary release of the feature across NFs within a signaling path in the communication network.

According to a fifth aspect of the present disclosure, there is provided a second network node, comprising: at least one processor; and at least one memory, coupled with the at least one processor and stored thereon instructions which, when executed by the at least one processor, cause the second Network node to perform any of the methods for network canary orchestration according to related embodiments of the present disclosure.

According to a sixth aspect of the present disclosure, there is provided a computer program comprising computer program instructions which, when executed by a processor in a first network node or a second first network node, causing the first network node or the second first network node to perform respective methods according to the embodiments of the present disclosure.

According to a seventh aspect of the present disclosure, there is provided a computer readable storage medium having stored thereon a computer program as described in the context.

According to an eighth aspect of the present disclosure, there is provided a computer program product comprising a computer program and a computer readable storage medium as described in the context.

With the proposed technical solutions according to the exemplary aspects of the present disclosure as described above, a network canary orchestrator (NCO) is provided as a novel component. Further, it may provide at least the following novel procedures or features implemented by the NCO:
The selection of affected Producer NFs
The configuration of a new NF Service and its mapping to the upgraded feature
The configuration of the NF Service in the NF profile with the traffic steering criteria, reusing existing NF Service profile attributes
The configuration to provide an orchestration for canary release of an end-to-end feature at network level which across network functions in multiple vendor scenarios

The proposed solution in the embodiments of the present disclosure enables support for canary upgrades at network level without requiring awareness of the canary release in the Consumer NFs, reusing discovery mechanisms available in the standard NF Profile. Further, this enables the control of the network level impacted scope and end to end feature upgrades rhythm in a central place.

### BRIEF DESCRIPTION OF THE DRAWINGS

The objects, advantages and characteristics of the present disclosure will be more apparent, according to descriptions of preferred embodiments in connection with the drawings, wherein:

FIG. 1 schematically illustrates the SBA non-roaming architecture;

FIG. 2 schematically illustrates the architecture including a network canary orchestrator (NCO) according to an embodiment of the present disclosure;

FIG. 3 schematically illustrates a flowchart for network canary orchestration according to an embodiment of the present disclosure;

FIG. 4 schematically illustrates a method performed by a first network node for network canary orchestration according to an embodiment of the present disclosure;

FIG. 5 schematically illustrates a method performed by a second network node participating in the canary release according to an embodiment of the present disclosure;

FIG. 6 schematically illustrates a first network node for network canary orchestration according to an embodiment of the present disclosure;

FIG. 7 schematically illustrates a network node including a first network node for network canary orchestration according to an embodiment of the present disclosure; and

FIG. 8 schematically illustrates a second network node participating in the canary release according to an embodiment of the present disclosure.

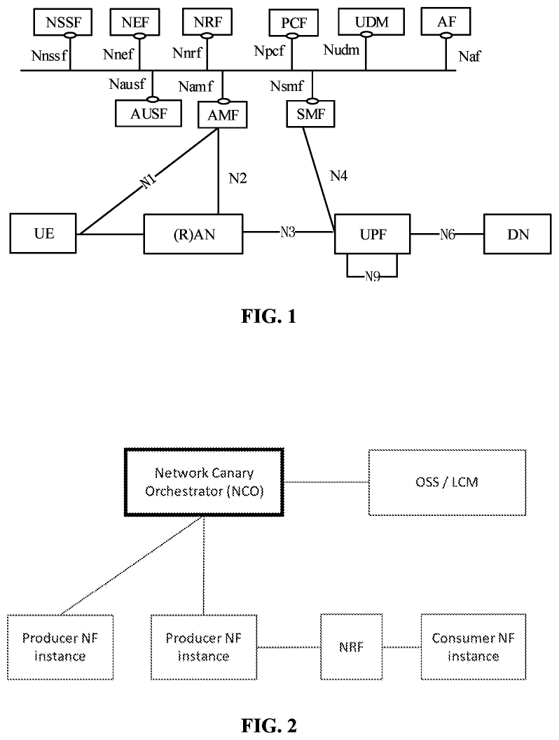

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Additional information may make reference to the following documents, which are incorporated herein in their entirety by reference:
[1] 3GPP TS 23.501 v17.3.0 System architecture for the 5G System (5GS); Stage 2
[2]. 3GPP TS 29.510 v17.4.0 5G System; Network function repository services; Stage 3

References in this specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of the skilled in the art to affect such feature, structure, or characteristic in connection with other embodiments whether or not explicitly described.

In the context, a “network node” is any node that is either part of the core network of a cellular communications network/system or any other applicable communication network/system.

FIG. 2 schematically illustrates the architecture including a network canary orchestrator (NCO) according to an embodiment of the present disclosure.

As an example, the architecture in FIG. 2 may include at least a Network Canary Orchestrator (NCO), an Operation and Support System (OSS) or Life Cycle Management (LCM), Producer NFs (instances), a Network Registration Function (NRF) and Consumer NFs (instances). The NRF may provide the discovery of services. The Producer NF may expose the services and register the services in the NRF, and the Consumer NF may query the NRF for the services to be consumed.

The NCO may have the following interfaces:
a first interface towards the Operation and Support System (OSS) or Life Cycle Management (LCM) solution used to manage the upgrades of the NFs in the network. For this interface, the NCO can extract information about which features are introduced using canary release, and which Producer NFs are participating in the canary release of the feature.
a second interface towards the North Bound Interface (NBI) for Operation, Administration and Maintenance (OAM) of the Producer NFs. This interface is used to perform configuration on the Producer NF. A possible realization of this interface is based on e.g., a Network Configuration Protocol referring to RFC 6241, NetCONF.

The NCO function can be realized as a separate entity, or collocated with other functions of the OSS management domain, e.g. within the NFV Orchestrator in the context of European Telecommunications Standards Institute Management and Network Orchestration (ETSI-MANO).

The NCO may provide the orchestration for canary release of features across the NFs e.g., in a 5G Core Network, or other applicable communication networks where the orchestration for canary release may be applied, e.g., the network supporting network registration and service discovery functions.

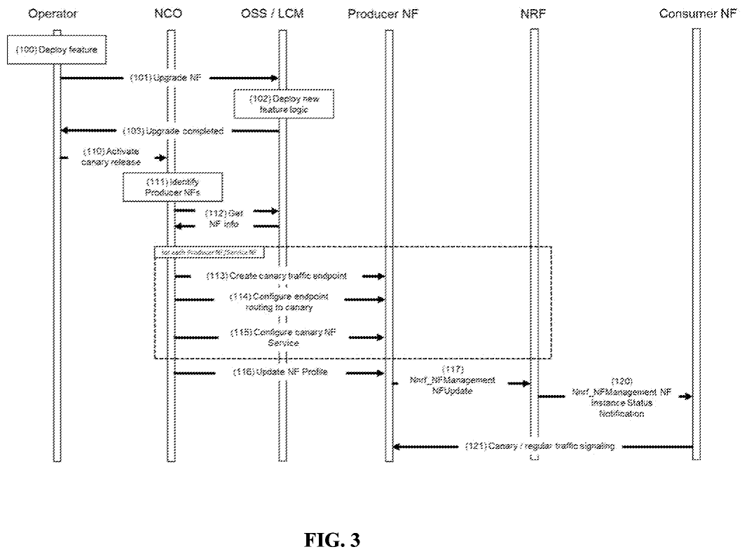

FIG. 3 schematically illustrates a flowchart for network canary orchestration according to an embodiment of the present disclosure.

The operations related to the present disclosure are described with the help of the signaling flow shown in FIG. 3.

At step 100, the network operator decides to deploy a new feature using canary. The operator could also deploy a change on an existing feature. In both cases, the process is basically the same.

At step 101, it upgrades the target NFs in the network with a new Software (SW) package. The SW package contains the logic for the new feature. Target NFs can be both Consumer and Producer NFs.

At step102, both the previous and new feature logic are loaded/deployed in the target NFs, and the upgrade is completed at step 103. The new feature is not yet activated, so the traffic flows through the previous software logic.

At step 110, the operator decides to activate the canary release, and it may configure the NCO with the feature to be activated, and a traffic steering criteria.

Let us assume that the operator wishes to send, e.g., a percentage of traffic through the canary. It may configure the NCO with the percentage to use.

At step 112, the NCO may either uses local configuration or queries the OSS/LCM function to identify the Producer NFs, and its affected NF Services participating in the canary release of the feature.

For each of Producer NFs identified, the NCO may use the North Bound Interface (NBI) interface of the Producer NF to perform the following configuration on the Producer NF.
For each of the NF Services offered by the Producer NF that are impacted by the canary feature:
   At step 113, the NCO may create a new traffic receiving endpoint in the South Bound signaling interface (SBI), that shall be used to receive canary traffic. The endpoint may use a dedicated IP address, a dedicated FQDN, a dedicated port, a dedicated API root, or any combination of them; so that it is possible to receive both canary and regular traffic separately.
   At step 114, the NCO may configure the internal routing of the Producer NF so that traffic reaching said traffic endpoint is handled by the new feature logic.
   At step 115, the NCO may create a new NF Service in the NF Profile of the Producer NF, with the same serviceName than the previous one. It may provide the details of the endpoint created in the previous steps, by setting the fqdn, ipEndpoints, apiPrefix attributes of the NF Service profile, as needed. In case deploying a total new feature, which relies on a new NF service type, the new NF service profile may be created by NCO with the new serviceName.
   At this point, the NF Profile may contain two NF Services of the same type, the previous and the new one, with different Endpoints. Each NF Service processing traffic (i.e., canary and regular traffic) through the new and previous logic, respectively.
   The NCO may set the priority attribute of both NF Services to the same value. According to 3GPP TS 29.510, section 6.2.6.2.4, this may make Producer NFs to distribute the incoming traffic based on the capacity attribute.
   The NCO may set the capacity attribute of each NF Service to achieve the desired traffic percentage passed through the canary. For instance, to achieve a 10% of the traffic to go through the canary, the capacity value of the previous NF Service should be set to 90, and the capacity value of the new NF Service should be set to 10.
At step 116, the NCO may instruct the Producer NF (116) to publish the update NF Profile in the NRF (117).

As step 120, the Consumer NFs that are subscribed to changes in the NF Profile of the affected Producer NFs may receive a notification from the NRF, which may cause the Consumer NFs to discover the new NF Service corresponding to the canary feature.

As step 120, the Consumer NF may start sending traffic to either the previous or new canary NF Service endpoints of the Producer NF honoring the priority and capacity attributes. This may result in the desired percentage of traffic being sent to the canary feature, without any awareness on the Consumer NF of the canary mechanism in place.

The operator may decide to vary the percentage of the traffic steering criteria over time on the NCO. When such percentage is changed, the NCO may configure the Producer NFs with updated capacity values for both NF Services, and instruct the Producer NF to publish the update NF Profile in the NRF.

Eventually, the operator may decide to fully rollout the feature by terminating the canary. The NCO may perform the following operations on the affected Producer NFs:
The NCO may remove the original (non-upgraded) NF Service from the NF Profile. Optionally, it may reset the priority and capacity values of the new NF Service to their defaults;
The NCO may make the Producer NF to publish the updated NF Profile in the NRF; and
The NCO may remove the original (not-upgraded) traffic receiving endpoint in the SBI.

At this point, there is a single NF Service of the affected type, receiving all traffic.

FIG. 4 schematically illustrates a method 400 performed by a first network node 600 for network canary orchestration according to an embodiment of the present disclosure.

The method 400 for an automatic orchestration for network canary is performed by a first network node. The first network node may be or include a network function or a network function entity referred to as a network canary orchestrator (NCO) in a 5G core network or other applicable communication network, especially across a multi-vendor network.

The method includes step S401 and step S403. At step S401, the first network node receives an indication for activating canary release of a feature in the network. At S403, upon receiving the indication, the first network node provides an automatic orchestration for the canary release of the feature across network functions, NFs, within a signaling path in the network.

Generally, the network functions in the network may at least include Producer NFs and Consumer NFs. As described, the Producer NFs may expose services by registering a profile within the Network Registration Function (NRF) where the services offered by the Producer NF and how to consume the services may be described. The Consumer NFs may query the NRF for services being consumed, to obtain the required service information.

In the context, the signaling path may refer to an end to end signal path for implementing an end to end feature across multiple NFs e.g. in the 5G core communication network or other applicable communication network, especially a multi-vendor communication network.

In an embodiment, in the procedure of providing an automatic orchestration, the first network node may identify only the Producer NFs within the signaling path that requires activation of the canary release of the feature while the Consumer NFs within the signaling path need not know the canary release and thus not be identified.

In the procedure of providing an automatic orchestration, the first network node may extract from e.g. an Operation and Support System (OSS) or Life Cycle Management (LCM) function entity, via a first interface, information about the feature with the canary release to be activated and the Product NFs participating in the canary release; and perform, via a second interface, configuration on the Producer NF (or Producer NF instances) participating in the canary release.

In the procedure of providing an automatic orchestration, the first network node may receive, from the Operator, configuration on the feature with the canary release to be activated and traffic steering criteria for handling canary traffic. The traffic steering criteria may also be referred to as traffic selection criteria in the context.

In the procedure of providing an automatic orchestration, the first network node may identify the Producer NFs and respective impacted NF services offered by the Producer NFs participating in the canary release of the feature based on local configuration or querying via the first interface from the OSS/LCM.

For each of the Producer NFs, in the procedure of providing an automatic orchestration, the first network node may send, for each of the NF services offered by the Producer NF, an instruction to the Producer NF via the second interface for performing following operations: exposing a new NF service for receiving the canary traffic; determining an internal routing within the Producer NF for routing the canary traffic and regular traffic respectively based on the traffic steering criteria; and configuring, in a NF profile of the Producer NF, the new NF service and the traffic steering criteria.

When exposing a new NF service for receiving the canary traffic, the first network node may create a new traffic receiving endpoint corresponding to the new NF service for receiving the canary traffic using at least one of a dedicated IP address, a dedicated FQDN, a dedicated port, and a dedicated API root. At the time, as an example, for upgrading a feature from old version, there exists a new traffic receiving endpoint corresponding to the new NF service for receiving the canary traffic and an old traffic receiving endpoint corresponding to the prior NF service for receiving the regular traffic. As another example, for deploying a total new feature with canary release, there may only exist the new traffic receiving endpoint corresponding to the new NF service for receiving the canary traffic.

Correspondingly, for upgrading a feature from old version, the new NF service has the same service name and different traffic receiving endpoint from the prior NF service.

In an embodiment, in the procedure of providing an automatic orchestration, the first network node may set priority attribute and capacity attribute for the new NF service and the prior NF service. Through the setting of the priority attribute and capacity attribute, flexible e.g., traffic percentage for the canary release may be achieved as desired by setting the priority attributes of the new NF service and the prior NF service to be the same.

The first node may further instruct the Producer NF to publish, in a Network Registration Function (NRF) the NF profile which may contain at least the new NF service for receiving the canary traffic and the traffic steering criteria for handling canary traffic.

The traffic steering criteria may include, among others, configuration on a percentage of the canary traffic.

In an embodiment, when the configuration on the percentage of the canary traffic is changed, the first network node may send an instruction to the Producer NFs for updating the NF profiles of the Producer NFs and publishing the updated NF profiles in the NRF.

In an embodiment, when fully rolling out the feature by terminating the canary release, the first network node may send an instruction to the Producer NFs for performing at least following operations: updating the NF profile of each of the Producer NFs participating in the canary release by removing the prior NF service from the NF profile; publishing the updated NF profile in the NRF; and removing prior traffic receiving endpoint corresponding to the prior NF service. The new traffic receiving endpoint created earlier for the canary release will be responsible for receiving the entire traffic.

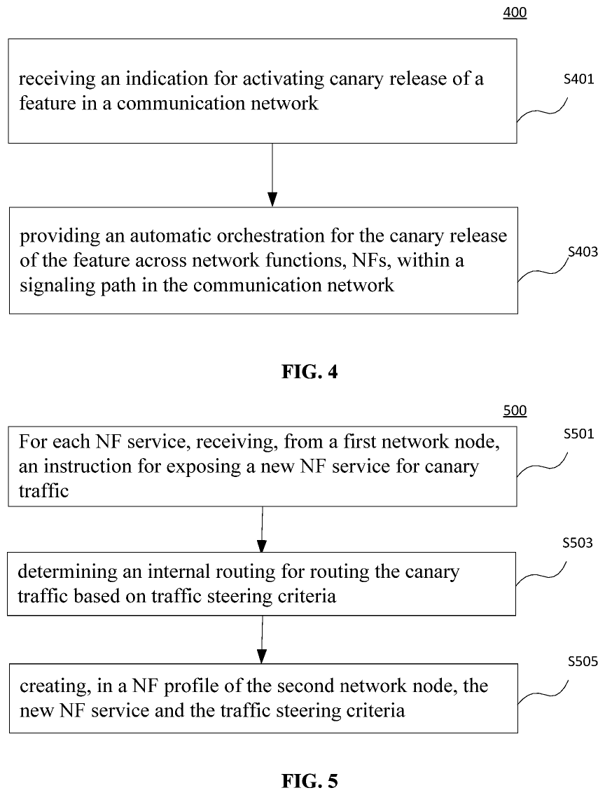

FIG. 5 schematically illustrates a method 500 performed by a second network node participating in the canary release according to an embodiment of the present disclosure.

The method 500 for the canary release may be performed by a second network node 800. The second network node 800 may be a Producer NF participating in the canary release of the feature in a 5G core network or other applicable communication network, especially across a multi-vendor network.

In the method 500, for each of network function services offered by the second network node participating in canary release of a feature, the second network node receives, from a first network node, an instruction for exposing a new NF service for receiving canary traffic at step S501. For each NF service, an internal routing is determined within the second network node for routing the canary traffic and the regular traffic respectively based on traffic steering criteria for handling the canary traffic at step S503. For each NF service, the new NF service and the traffic steering criteria are included in a NF profile of the second network node at step S505.

When exposing a new NF service for receiving the canary traffic, a new traffic receiving endpoint corresponding to the new NF service may be created for receiving the canary traffic using at least one of a dedicated IP address, a dedicated FQDN, a dedicated port, and a dedicated API root. At the time, as an example, for upgrading a feature from old version, there exists a new traffic receiving endpoint corresponding to the new NF service for receiving the canary traffic and an old traffic receiving endpoint corresponding to the prior NF service for receiving the regular traffic. As another example, for deploying a total new feature with canary release, there may exist only the new traffic receiving endpoint corresponding to the new NF service for receiving the canary traffic.

Correspondingly, for upgrading a feature from old version, the new NF service may have the same service name and different traffic receiving endpoint from the prior NF service.

In response to receiving an instruction from the first network node, the second network node may publish, in the NRF, the NF profile including at least the new NF service for receiving the canary traffic and the traffic steering criteria for handling the canary traffic.

The traffic steering criteria may include at least configuration on a percentage of the canary traffic.

In an embodiment, when the configuration on the percentage of the canary traffic is changed, the second network node may receive an instruction from the first network node for updating the NF profile and publishing the updated NF profile in the NRF.

In a further embodiment, when fully rolling out the feature by terminating the canary release, the second network node may receive an instruction from the first network node for performing the following operations: the NF profile of the second Network node may be updated by removing the prior NF service from the NF profile; the updated NF profile may be published in the NRF; and the prior traffic receiving endpoint corresponding to the prior NF service may be removed.

In the embodiments of the method, the first network node may be or include a network canary orchestrator (NCO) configured to provide an automatic orchestration for the canary release of the feature across NFs within a signaling path in the communication network, especially in a multi-vendor network.

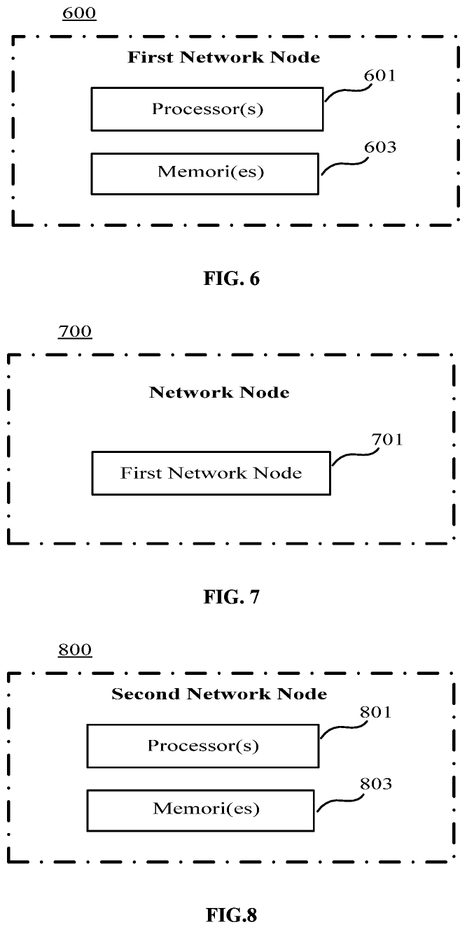

FIG. 6 schematically illustrates a first network node 600 for network canary orchestration according to an embodiment of the present disclosure. The first network node is a network node which may be or include a network function or a network function entity supporting a centralized automatic network canary orchestration in 5G core network or other applicable communication networks, especially multi-vendor networks.

In an embodiment, the first network node 600 may include at least one processor 601 and at least one memory 603. The memory is coupled with the at least one processor. The instructions stored on the memory, when executed by the at least one processor, may cause the first network node to perform a method 500 for network canary orchestration, including: receiving an indication for activating canary release of a feature in a communication network; and providing an automatic orchestration for the canary release of the feature across network functions, NFs, within a signaling path in the communication network.

To provide an automatic orchestration for the canary release, the instructions may also cause the first network node to identify Producer NFs within the signaling path that requires activation of the canary release of the feature without awareness of the canary release in Consumer NFs within the signaling path.

The first network node may at least include a first interface (also referred to as a North bound interface, NBI) and a second interface (also referred to as a South bound interface, SBI). The NBI may be configured for extracting, from the OSS/LCM, information about the feature with the canary release to be activated and the Product NFs participating in the canary release. The SBI may be configured for performing configuration on the Producer NFs participating in the canary release.

To provide an automatic orchestration for canary release, the first network node may receive configuration on the feature having the canary release to be activated and traffic steering criteria for handling canary traffic.

To provide an automatic orchestration for canary release, the first network node may further identify the Producer NFs and respective impacted NF services offered by each Producer NF participating in the canary release of the feature based on local configuration or querying via the first interface from the OSS/LCM.

For each Producer NF, to provide an automatic orchestration for canary release, the first network node may send an instruction to the Producer NF via the second interface for performing following actions for each of the NF services offered by the Producer NF, including: exposing a new NF service for receiving the canary traffic; determining an internal routing within the Producer NF for routing the canary traffic and the regular traffic respectively based on the traffic steering criteria; and creating, in a NF profile of the Producer NF, the new NF service and the traffic steering criteria.

For exposing a new NF service for receiving the canary traffic, the first network node may create a new traffic receiving endpoint corresponding to the new NF service for receiving the canary traffic. A dedicated IP address, a dedicated FQDN, a dedicated port, and/or a dedicated API root may be used for creating a new traffic receiving endpoint.

The new NF service may be created by having the same service name and different traffic receiving endpoint than prior NF service.

To provide an automatic orchestration for canary release, the first network node may set priority attribute and capacity attribute of the new NF service and the prior NF service.

To provide an automatic orchestration for canary release, the first network node may instruct the Producer NF to publish the NF profile in the NRF. The NF profile may contain at least the new NF service for receiving the canary traffic and the traffic steering criteria for handling the canary traffic.

The traffic steering criteria may include configuration on at least a percentage of the canary traffic.

In an embodiment, when the configuration on the percentage of the canary traffic is changed, the first network node may send an instruction to the Producer NFs for updating the NF profiles and publishing the updated NF profiles in the NRF.

In a further embodiment, when fully rolling out the feature by terminating the canary release, to provide an automatic orchestration, the first network node may send an instruction to the Producer NFs for performing following actions, including: updating the NF profile of each of the Producer NFs participating in the canary release by removing the prior NF service; publishing the updated NF profile in the NRF; and removing prior traffic receiving endpoint corresponding to the prior NF service.

In an embodiment, the first network node may include a receiving module for receiving an indication for activating canary release of a feature in a communication network; and a providing module for providing an automatic orchestration for the canary release of the feature across network functions, NFs, within a signaling path in the communication network. The providing module for providing an automatic orchestration for the canary release may further perform operations as described in other embodiments with reference to other Figures.

FIG. 7 schematically illustrates a network node 700 in a 5G core network according to an embodiment of the present disclosure. The network node may include a network canary orchestrator (NCO) as indicated by 701 for providing a centralized automatic network canary orchestration as described in the embodiments of the present disclosure. For simplicity, similar description related to the NCO will not be repeated.

FIG. 8 schematically illustrates a second network node 800 participating in the canary release according to an embodiment of the present disclosure.

The second network node 800 may include at least one processor 801 and at least one memory 803. The memory 803 is coupled with the at least one processor. Instructions stored on the memory, when executed by the at least one processor, may cause the second Network node to perform the method 500 as described with reference to FIG. 5.

In another embodiment, the second network node may include a first module for receiving, from a first network node 600, an instruction for each of network function, NF, services offered by the second network node participating in canary release of a feature. The second network node is instructed to expose a new NF service for receiving canary traffic; determine an internal routing for routing the canary traffic based on traffic steering criteria for handling the canary traffic; and creating, in a NF profile of the second network node, the new NF service and the traffic steering criteria. The first module may be further configured to perform other operations as described with reference to FIG. 5.

According to an embodiment of the present disclosure, a computer program comprising computer program instructions may be provided. The instructions, when executed by a processor in a first network node or a second first network node, may cause the first network node to perform the method as described with reference to FIG. 4, or the second first network node to perform the method as described with reference to FIG. 5.

According to an embodiment of the present disclosure, a computer readable storage medium may be provided by having stored thereon a computer program as described above.

According to an embodiment of the present disclosure, a computer program product may also be provided by including a computer program and a computer readable storage medium as described above.

Many different embodiments have been disclosed herein, in connection with the above description and the drawings. It will be understood that it would be unduly repetitious and obfuscating to literally describe and illustrate every combination and sub-combination of these embodiments. Accordingly, all embodiments can be combined in any way and/or combination, and the present specification, including the drawings, shall be construed to constitute a complete written description of all combinations and sub-combinations of the embodiments described herein, and of the manner and process of making and using them, and shall support claims to any such combination or sub-combination.

As will be appreciated by one of skill in the art, the concepts described herein may be embodied as a method, a network node, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, operation, action and/or functionality described herein may be performed by, and/or associated to, a corresponding module, which may be implemented in software and/or firmware and/or hardware. Furthermore, the present disclosure may take the form of a computer program product on a tangible computer usable storage medium having computer program instructions embodied in the medium that can be executed by a computer. Any suitable tangible computer readable medium may be utilized including hard disks, CD-ROMs, electronic storage devices, optical storage devices, or magnetic storage devices.

It is to be understood that the steps/acts noted in the blocks may occur out of the order noted in the operational illustrations. For example, two blocks shown in succession may in fact be executed substantially concurrently or the blocks may sometimes be executed in the reverse order, depending upon the steps/acts involved. Although some of the diagrams include arrows on communication paths to show a primary direction of communication, it is to be understood that communication may occur in the opposite direction to the depicted arrows.

It will be appreciated by persons skilled in the art that the embodiments described herein are not limited to what has been particularly shown and described herein above. A variety of modifications and variations are possible in light of the above teachings.

Abbreviations

| Abbreviation | Explanation |
|---|---|
| 3GPP | the Third Generation Partnership Project |
| 5G | the Fifth Generation |
| API | Application Programming Interface |
| ETSI | European Telecommunications Standards Institute |
| FQDN | Fully Qualified Domain Name |
| LCM | Life-Cycle Management |
| MANO | Management and Network Orchestration |
| NBI | North Bound Interface |
| NCO | Network Canary Orchestrator |
| NF | Network Function |
| NFV | Network Function Virtualization |
| NRF | Network Repository Function |
| OAM | Operation, Administration and Maintenance |
| OSS | Operation Supports System |
| SBA | Service Based Architecture |
| SBI | South Bound Interface |
| SW | Software |

1. A first network node, comprising:
at least one processor; and
at least one memory, coupled with the at least one processor and stored thereon instructions which, when executed by the at least one processor, cause the first network node to perform operations comprising:
receiving an indication for activating canary release of a feature in a communication network; and
providing an automatic orchestration for the canary release of the feature across network functions, NFs, within a signaling path in the communication network.

2.-13. (canceled)

14. A method performed by a first network node, comprising:
receiving an indication for activating canary release of a feature in a communication network; and
providing an automatic orchestration for the canary release of the feature across network functions, NFs, within a signaling path in the communication network.

15. The method of claim 14, wherein the providing an automatic orchestration comprises:
identifying Producer NFs within the signaling path that requires activation of the canary release of the feature without awareness of the canary release in Consumer NFs within the signaling path.

16. The method of claim 14, wherein the providing an automatic orchestration further comprises:
extracting, via a first interface, information about the feature with the canary release to be activated and the Product NFs participating in the canary release; and
performing, via a second interface, configuration on the Producer NFs participating in the canary release.

17. The method of claim 14, wherein the providing an automatic orchestration further comprises:
receiving configuration on the feature with the canary release to be activated and traffic steering criteria for handling canary traffic.

18. The method of claim 14, wherein the providing an automatic orchestration further comprises:
identifying the Producer NFs and respective NF services participating in the canary release of the feature based on local configuration or querying via the first interface.

19. The method of claim 14, wherein, for each of the Producer NFs, the providing an automatic orchestration further comprises: for each of the NF services offered by the Producer NF, sending an instruction to the Producer NF via the second interface for performing operations comprising:
exposing a new NF service for receiving the canary traffic;
determining an internal routing within the Producer NF for routing the canary traffic based on the traffic steering criteria; and
configuring, in a NF profile of the Producer NF, the new NF service and the traffic steering criteria.

20. The method of claim 19, wherein the exposing a new NF service for receiving the canary traffic comprises:
creating a new traffic receiving endpoint corresponding to the new NF service for receiving the canary traffic using at least one of a dedicated IP address, a dedicated FQDN, a dedicated port, and a dedicated API root.

21. (canceled)

22. The method of claim 19, wherein the new NF service has the same service name and different traffic receiving endpoint than a prior NF service, and wherein the providing an automatic orchestration further comprises:
setting a priority attribute and capacity attribute of the new NF service and the prior NF service.

23. The method of claim 19, further comprising:
instructing the Producer NF to publish, in a Network Registration Function, NRF, the NF profile containing at least the new NF service for receiving the canary traffic and the traffic steering criteria for handling canary traffic.

24. The method of claim 17, wherein the traffic steering criteria comprises at least configuration on a percentage of the canary traffic.

25. The method of claim 24, wherein, when the configuration on the percentage of the canary traffic is changed, the providing an automatic orchestration further comprises sending an instruction to the Producer NFs for performing operations, sending the instruction comprising:
updating the NF profiles of the Producer NFs and publishing the updated NF profiles in the NRF.

26. The method of claim 14, wherein, when fully rolling out the feature by terminating the canary release, the providing an automatic orchestration further comprises sending an instruction to the Producer NFs for performing operations, sending the instruction comprising:
updating the NF profile of each of the Producer NFs participating in the canary release by removing the prior NF service;
publishing the updated NF profile in the NRF; and
removing prior traffic receiving endpoint corresponding to the prior NF service.

27. (canceled)

28. A method performed by a second network node, comprising: for each of network function, NF, services offered by the second network node participating in canary release of a feature, receiving, from a first network node, an instruction for performing operations comprising:
exposing a new NF service for receiving canary traffic;
determining an internal routing within the second network node for routing the canary traffic based on traffic steering criteria for handling the canary traffic; and
creating, in a NF profile of the second network node, the new NF service and the traffic steering criteria.

29. The method of claim 28, wherein the exposing a new NF service for receiving the canary traffic comprises:
creating a new traffic receiving endpoint corresponding to the new NF service for receiving the canary traffic using at least one of a dedicated IP address, a dedicated FQDN, a dedicated port, and a dedicated API root.

30. (canceled)

31. The method of claim 28, further comprising:
in response to receiving an instruction from the first network node, publishing, in a Network Registration Function, NRF, the NF profile including at least the new NF service for receiving the canary traffic and the traffic steering criteria for handling the canary traffic.

32. The method of claim 28, wherein the traffic steering criteria comprises at least configuration on a percentage of the canary traffic.

33. The method of claim 32, wherein, when the configuration on the percentage of the canary traffic is changed, the method further comprises receiving an instruction from the first network node for performing operations, receiving the instruction comprising:
updating the NF profile and publishing the updated NF profile in the NRF.

34. The method of claim 28, wherein, when fully rolling out the feature by terminating the canary release, the method further comprises receiving an instruction from the first network node for performing operations, receiving the instruction comprising:
updating the NF profile of the second Network node by removing the prior NF service;
publishing the updated NF profile in the NRF; and
removing prior traffic receiving endpoint corresponding to the prior NF service.

35. The method of claim 28, wherein the second Network node is a Producer NF participating in the canary release of the feature in a communication network, and the first network node is or comprises a network canary orchestrator, NCO configured to provide an automatic orchestration for the canary release of the feature across NFs within a signaling path in the communication network.

36.-39. (canceled)
